(19) United States
(12) Patent Application Publication
(10) Pub. No.: US 2011/0016970 A1
(43) Pub. Date: Jan. 27, 2011

(54) LIQUID LEVEL DETECTING DEVICE

(75) Inventor: Akira Sakamaki, Niigata (JP)

Correspondence Address: MCDERMOTT WILL & EMERY LLP, 600 13TH STREET, N.W., WASHINGTON, DC, 20005-3096, US

(73) Assignee: Nippon Seiki Co., Ltd.

(21) Appl. No.: 12/934,164

(22) PCT Filed: Mar. 16, 2009
(86) PCT No.: PCT/JP2009/055023

§ 371 Date: Sep. 23, 2010

(30) Foreign Application Priority Data
Mar. 31, 2008 (JP) 2008-089026

(51) Int. Cl. G01F 23/36

(52) U.S. Cl. 73/317

(57) ABSTRACT

Provided is a liquid level detecting device having a small holder fixing structure. A liquid level detecting device (F) is provided with a float arm (1) which turns corresponding to a change of a liquid level, and a sensing section (2) which outputs a residual quantity signal indicating a residual quantity of the liquid level with turning operation of the float arm (1). The liquid level detecting device is also provided with a first holder (4) for holding the float arm (1); a second holder (5) for turning the constituting components of the sensing section (2) based on the turning operation of the first holder (4); a rotating shaft (6) arranged on the first holder (4) or the second holder (5); a main body (8) having a bearing (7) which corresponds to the rotating shaft (6); a first connecting section (9) arranged on the rotating shaft (6); and a second connecting section (10), which is arranged on the other holder of the first and the second holders (4, 5) and fixes the first connecting section (9).

### TECHNICAL FIELD

The present invention relates to a liquid level detecting device and, more specifically, to a liquid level detecting device characterized by a fixing structure between a float arm and a holder that holds components which constitute a sensing section.

### BACKGROUND ART

A liquid level detecting device in the related art includes a float arm configured to rotate in accordance with variations in liquid level and a sensing section configured to output remaining amount signals which indicate remaining amounts of liquid level in accordance with a rotating action of the float arm. The sensing section includes a resistance panel and a movable contact point which slides on the resistance panel in accordance with the rotation of the float arm.

The float arm and the movable contact point are configured in such a manner that the float arm and the movable contact point move in conjunction with each other by fixing a holder having the movable contact point to a shaft at a connecting section which holds the other end portion of the float arm by means of press-fitting or the like.

Patent Document 1: JP-A-6-43008

### DISCLOSURE OF INVENTION

### Problems to be Solved by the Invention

However, the liquid level detecting device in the related art requires a significant thickness in the direction of the axis of rotation of the shaft of the holder for the purpose of securing a contact surface area between the holder and the shaft for reliably fixing the holder to the shaft by means of the press-fitting or the like. Therefore, there is a problem that downsizing of the holder in the direction of the axis of rotation thereof is difficult. There is another problem that it affects the size of a case in the case of the liquid level detecting device having the sensing section stored in the sealed case.

In view of such problems described above, it is an object of the present invention to provide a liquid level detecting device which allows downsizing of a fixing structure of a holder.

### MEANS FOR SOLVING THE PROBLEMS

The present invention is a liquid level detecting device having a float arm configured to rotate in accordance with variations in liquid level, and a sensing section configured to output remaining amount signals which indicate remaining amounts of liquid level in accordance with a rotating action of the float arm, including: a first holder configured to hold the float arm; a second holder configured to rotate part of components of the sensing section on the basis of a rotating action of the first holder; a rotating shaft provided on either one of the first holder or the second holder; a body having a bearing corresponding to the rotating shaft; a first connecting section provided on the rotating shaft; and a second connecting section provided on the other one of the first and second holders and configured to fix the first connecting section.

The present invention is configured in such a manner that the first connecting section includes a hook, and the second connecting section includes a through hole which allows insertion of the hook therethrough, a restricting portion configured to restrict the rotation of the hook, and a positioning section configured to allow the hook to rotate only in one direction.

The present invention is also configured in such a manner that the first holder and the second holder are in colors different from each other.

### ADVANTAGES OF THE INVENTION

According to the present invention, a liquid level detecting device which achieves desired objects and allows downsizing of a fixing structure of a holder can be provided.

### BRIEF DESCRIPTION OF THE DRAWINGS

FIG. 1 is a top view of a liquid level detecting device according to a first embodiment of the present invention.

FIG. 2 is a cross-sectional view taken along the line A-A in FIG. 1.

FIG. 3 is a cross-sectional view taken along the line B-B in FIG. 1.

FIG. 4 is a perspective view of a first holder according to the same embodiment.

FIG. 5 is a perspective view of a second holder according to the same embodiment.

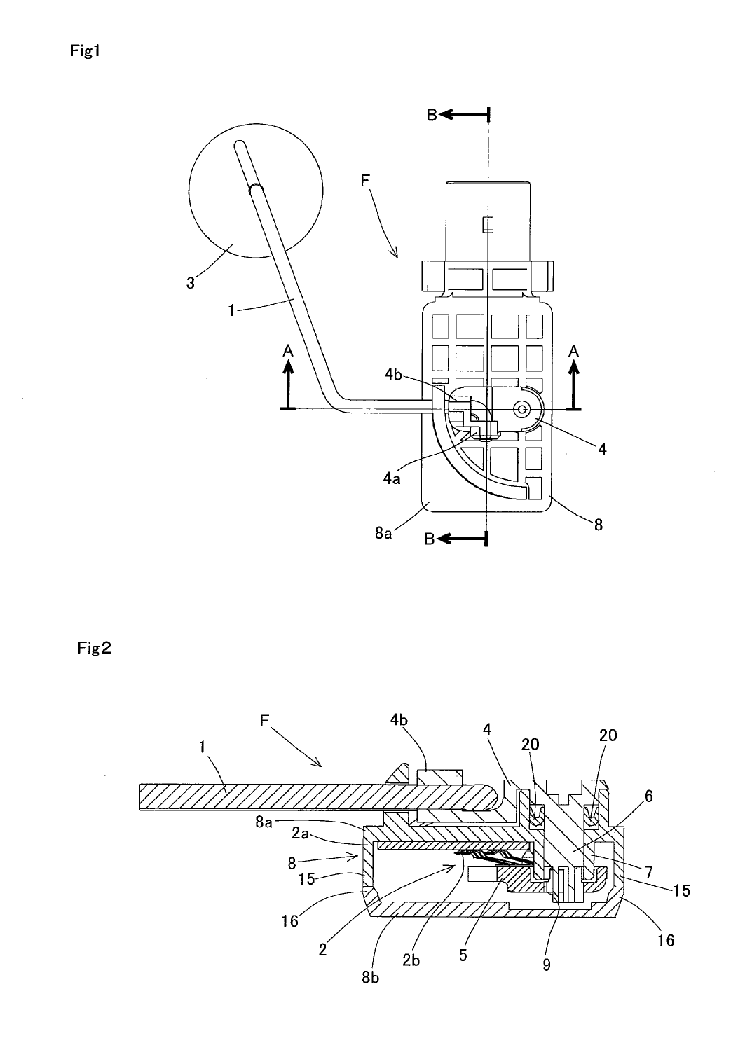

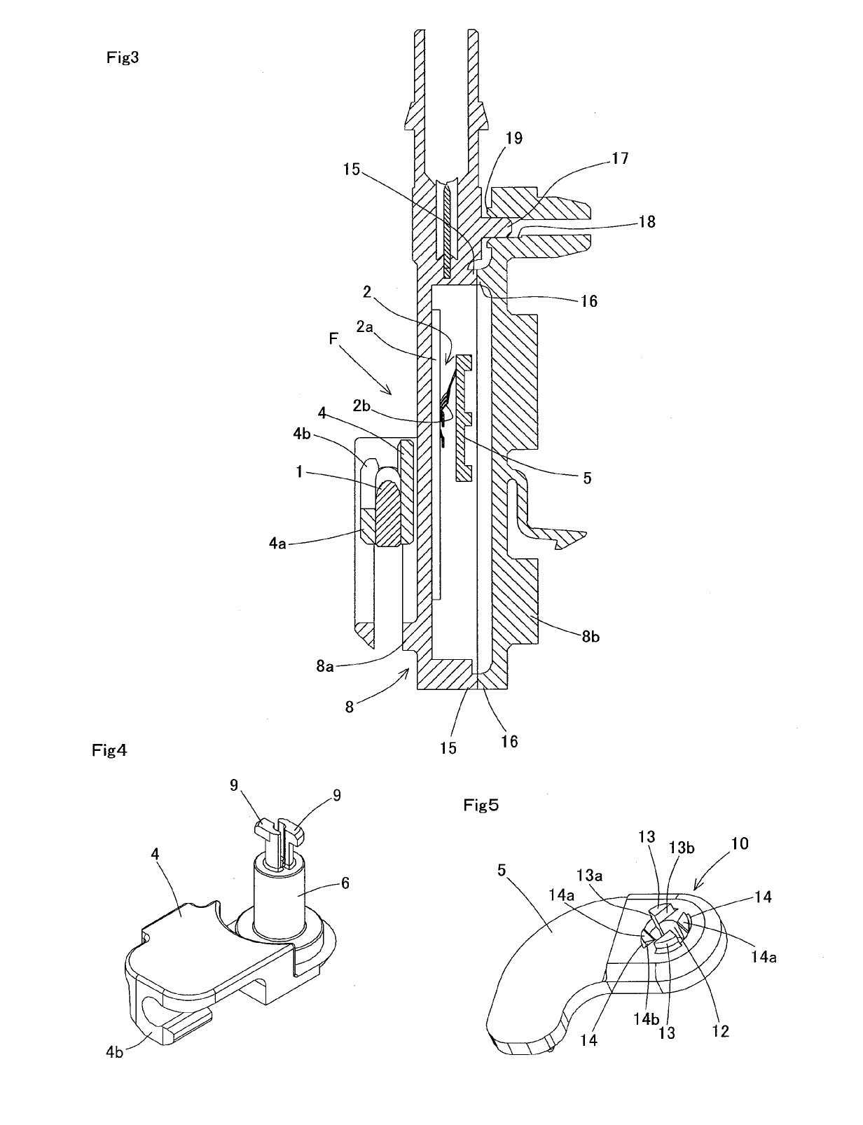

### REFERENCE NUMERALS

F liquid level detecting device
1 float arm
3 sensing section
4 first holder
5 second holder
6 rotating shaft
7 bearing
8 body
9 first connecting section
10 second connecting section
12 through hole
13 restricting portion
14 positioning section

### BEST MODES FOR CARRYING OUT THE INVENTION

Referring now to attached drawings, a first embodiment to which the present invention is applied will be described.

A liquid level detecting device F in the present invention mainly includes a float arm 1, a sensing section 2, a first holder 4 that holds the float arm 1, a second holder 5 that holds part of components of the sensing section 2, and a body 8 that accommodates the sensing section 2.

The float arm 1 is formed of metal and includes at one end thereof a float 3 which floats on a liquid surface. It is held at the other end by the first holder 4. The float arm 1 seesaws in accordance with variations in liquid level, and rotates about a rotating shaft 6 provided on the first holder 4.

The sensing section 2 is configured to output remaining amount signals which indicate remaining amounts of liquid level in accordance with a rotating action of the float arm 1 and, in this embodiment, includes a circuit substrate 2a and a contact point member 2b. The circuit substrate 2a includes an insulative base member formed of ceramic and a resister, not shown, and a plurality of sliding electrodes formed thereon. The plurality of sliding electrodes are electrically connected independently to the resister. The contact point member 2b slides on the plurality of sliding electrodes. The contact point member 2b is formed of conductive metal and includes a plurality of contact points.

The first holder 4 is formed of synthetic resin and includes two holding portions 4a, 4b which hold the float arm 1 and the rotating shaft 6. The rotating shaft 6 includes at an end thereof two first connecting sections 9 each formed of a hook. The hooks which constitute the first connecting sections 9 project outward from the center axis of the rotating shaft 6.

The second holder 5 is formed of synthetic resin, and is configured to hold the contact point member 2b, which is part of components of the sensing section 2, in this embodiment. The second holder 5 includes a second connecting section 10 configured to rotate and fix the first connecting sections 9.

The second connecting section 10 includes a through hole 12 which allows insertion of the first connecting sections 9 therethrough, and restricting portions 13 and positioning sections 14 in the periphery of the through hole 12.

The through hole 12 has a shape which allows insertion of the two first connecting sections 9 therethrough.

Two each of the restricting portions 13 and the positioning sections 14 are provided. Then, they are provided alternately in the periphery of the through hole 12.

The restricting portions 13 are configured to restrict the rotation of the first connecting sections 9 inserted through the through hole 12, and each include two restricting surfaces 13a, 13b.

The restricting surfaces 13a are configured to restrict the clockwise rotation of the first connecting sections 9 having inserted through the through hole 12. The restricting surfaces 13b are configured to restrict the counterclockwise rotation of the first connecting sections 9 having through the through hole 12 and climbed over the positioning sections 14.

The positioning sections 14 are configured to allow the first connecting sections 9 to rotate only in one direction, and each include an inclined surface 14a and a restricting surface 14b configured to restrict the rotation.

The inclined surfaces 14a are configured to allow the clockwise rotation of the first connecting sections 9 having inserted through the through hole 12. However, when the first connecting sections 9 climb over the inclined surfaces 14a, the first connecting sections 9 are deformed toward the center of the rotating shaft 6. The restricting surfaces 14b are configured to restrict the counterclockwise rotation of the first connecting sections 9 having climbed over the inclined surfaces 14a.

In the configuration described above, the second holder 5 is fixed so as to rotate on the basis of a rotating action of the first holder 4.

Also, with the fixation by rotating the first connecting sections 9, downsizing in the direction of the rotating shaft 6 is achieved because the fixation is not based on press-fitting of the float arm 1 as in the related art. Also, in this embodiment, the first holder 4 is formed of white synthetic resin, the second holder 5 is formed of black synthetic resin, and the first and second holders 4, 5 are formed in colors different from each other. In this configuration, the fitting state between the first connecting sections 9 and the second connecting section 10 can easily be confirmed visually.

The body 8 includes a first case member 8a and a second case member 8b. Then, the body 8 accommodates the sensing section 2 in a sealed state.

The first case member 8a is formed of synthetic resin having a light-shielding property which does not allow transmission of light therethrough. Then, a bearing 7 configured to rotatably support the rotating shaft 6 is provided. The bearing 7 is a through hole. The first case member 8a is also provided with a wall portion 15 which constitutes a depression for accommodating the circuit substrate 2a.

The second case member 8b is formed of synthetic resin having a light-transmitting property which allows transmission of light therethrough. Then, a wall portion 16 which constitutes the depression that forms an accommodating space in cooperation with the first case member 8a is provided.

The wall portions 15, 16 of the first and second case members 8a, 8b are brought into abutment with each other and are welded with laser.

A reference numeral 17 designates a projection provided on the first case member 8a, and a reference numeral 18 designates a through hole provided on the second case member 8b. The positions of the first case member 8a and the second case member 8b can be set by fitting the projection 17 and the through hole 18, so that the position at the time of laser welding is fixed, whereby the positional displacement of the two members, namely, the first case member 8a and the second case member 8b at the time of welding can be prevented.

The second case member 8b is provided with a stopper 19 in the periphery of the through hole 18, which corresponds to a position apart from the wall portions 15, 16 to be welded, so as to project toward the first case member 8a. The stopper 19 is configured to control the melting amount of the first and second case members 8a, 8b when the first and second case members 8a, 8b are laser welded while being pressed against each other. In the configuration as described above, portions to be welded can be prevented from being excessively melted.

In this configuration, the widths (thicknesses) of the wall portions 15, 16 of the first and second case members 8a, 8b can be reduced and hence the liquid level detecting device F can be downsized.

A packing member 20 is mounted between the rotating shaft 6 and the bearing 7. In this embodiment, the packing member is formed of fluorine-contained rubber and the cross-sectional shape is a V-shape. With the provision of the packing member 20, the rotating shaft 6 can be disposed in a water-tight manner with respect to the bearing 7 of the first case member 8a.

It is also possible to provide a lubricating member on a sliding surface of the rotating shaft 6 of the packing member 20. The lubricating member is preferably fluorine grease, diamond-like carbon, or the like. The lubricating member may be provided also on the sliding surfaces on the outer periphery of the rotating shaft 6 and the inner periphery of the bearing 7. In the configuration as described above, abrasion due to a sliding movement of the rotating shaft 6 and the bearing 7 with respect to the packing member 20 is restrained, and hence the watertightness can be improved.

In this embodiment, the first holder 4 is provided with the rotating shaft 6 and also the first connecting sections 9, and the second holder 5 is provided with the second connecting section 10. However, the invention is not limited to this embodiment, and a configuration in which the second holder 5 is provided with the first connecting sections 9 as well as the rotating shaft 6, and the first holder 4 is provided with the second connecting section 10 is also applicable.

### INDUSTRIAL APPLICABILITY

The present invention relates to a liquid level detecting device and, more specifically, is applicable to a liquid level detecting device having a sensing section accommodated in a sealed case.

1. A liquid level detecting device having a float arm configured to rotate in accordance with variations in liquid level, and a sensing section configured to output remaining amount signals which indicate remaining amounts of liquid level in accordance with a rotating action of the float arm, comprising: a first holder configured to hold the float arm;
a second holder configured to rotate part of components of the sensing section on the basis of a rotating action of the first holder; a rotating shaft provided on either one of the first holder or the second holder; a body having a bearing corresponding to the rotating shaft; a first connecting section provided on the rotating shaft; and a second connecting section provided on the other one of the first and second holders and configured to fix the first connecting section.

2. The liquid level detecting device according to claim 1,
wherein the first connecting section includes a hook, and the second connecting section includes a through hole which allows insertion of the hook therethrough, a restricting portion configured to restrict the rotation of the hook, and a positioning section configured to allow the hook to rotate only in one direction.

3. The liquid level detecting device according to claim 1,
wherein the first holder and the second holder are in colors different from each other.
